(19) United States
(12) Patent Application Publication
(10) Pub. No.: US 2004/0126583 A1
(43) Pub. Date: Jul. 1, 2004

(54) Foaming agent for manufacturing a foamed or porous metal

(76) Inventors: Takashi Nakamura, Miyagi (JP); Ryoichi Ishikawa, Saitama (JP); Katsuhiro Shibata, Saitama (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/698,015

(22) Filed: Oct. 31, 2003

(30) Foreign Application Priority Data
Nov. 19, 2002 (JP) 2002-335622

(51) Int. Cl. B32B 5/16

(52) U.S. Cl. 428/403

(57) ABSTRACT

A foaming agent used for manufacturing a foamed or porous metal. The agent is composed of a foamable powder and a coating layer of SiO₂ covering the particle surfaces of the powder and having a good wetting property therewith.

### FIELD OF THE INVENTION

The present invention relates to a foaming agent used for manufacturing a foamed or porous metal (or alloy).

### BACKGROUND OF THE INVENTION

There is known a method of manufacturing a foamed or porous metal by adding a foaming agent to a molten or powdered metal and gasifying the foaming agent under heat or otherwise to form numerous pores in the metal (see, for example, Japanese Patent No. 2,898,437). In the narrow senses of the words, a foamed metal containing gas in its pores differs from one not containing such gas, but since they are equal in having numerous pores, they are herein referred to together as a foamed or porous metal.

Japanese Patent No. 2,898,437 gives 0.2% by weight of titanium hydride and sodium hydrogen carbonate as specific examples of a foaming agent. The use of titanium hydride or sodium hydrogen carbonate having a high reducing power is usual for foaming aluminum having a high affinity for oxygen. Titanium hydride and sodium hydrogen carbonate, however, have the drawback that they are expensive and raise the cost of manufacturing a foamed or porous metal. Moreover, they produce hydrogen gas which is so explosive as to call for the utmost care in handling and thereby impose a heavy burden on the workers. Thus, there is a serious demand for a foaming agent which can be used at a low cost without producing any danger of hydrogen explosion when manufacturing a foamed or porous metal.

### SUMMARY OF THE INVENTION

According to this invention, there is provided a foaming agent used for manufacturing a foamed or porous metal and comprising a foamable powder and a coating layer of SiO₂ covering the particle surfaces of the powder.

As SiO₂ has a good wetting property with molten aluminum, a foaming agent obtained by coating a foamable powder with a layer of SiO₂ can be distributed well in molten metal and thereby produce a foamed or porous metal of good quality having uniformly distributed pores.

The foaming agent obtained simply by coating a foamable powder with SiO₂ is inexpensive, and is free from any danger of hydrogen explosion, since the foamable powder does not contain any hydrogen radical. The foamable powder is preferably of a carbonate, such as calcium carbonate (CaCO₃) or magnesium carbonate (MgCO₃), as it produces carbon dioxide having no danger of explosion. Moreover, magnesium carbonate (MgCO₃) is preferred, since it is easily available and can be produced by the dehydration, etc. of highly stable basic magnesium carbonate (4 MgCO₃.Mg(OH₂).5H₂O).

### BRIEF DESCRIPTION OF THE DRAWINGS

A preferred embodiment of the present invention will be described in detail below, by way of example only, with reference to the accompanying drawings, in which:

FIGS. 1(a) and (b) are each a diagram explaining a contact angle;

FIG. 2 is a graph showing the contact angle and wetting property of different materials;

FIG. 3 is a flowchart showing a process for manufacturing a foaming agent according to this invention by co-precipitation;

FIG. 4 is a diagrammatic illustration of a particle of the foaming agent according to this invention;

FIG. 5 is a flowchart showing a process for manufacturing a foamed or porous metal by using the foaming agent according to this invention;

FIG. 6 is a flowchart showing a process for manufacturing a foaming gent according to this invention by evaporation; and

FIG. 7 is a graph showing the density of foamed or porous metals obtained by using different foaming agents.

### DETAILED DESCRIPTION OF THE PREFERRED EMBODIMENT

We, the inventors of this invention, first tried to reevaluate sodium carbonate as an inexpensive foaming agent not containing hydrogen. More specifically, we tried to manufacture a foamed metal by mixing a powder of sodium carbonate with molten aluminum. We cut a section from the foamed metal and examined it through a microscope. We found that the pores were undesirably large and in a small number per unit volume, as we had feared. We thought that the large pores had been formed by the combination of bubbles formed in the molten metal, and that as sodium carbonate had not uniformly been dispersed in molten aluminum because of its very low wetting property, its decomposition had formed a large amount of locally concentrated bubbles resulting in their mutual bombardment and growth into large pores.

Accordingly, we have reached the conclusion that the use of a substance having a good wetting property with molten aluminum as a new foaming agent will make it possible to restrain the combination of bubbles because of its uniform dispersion. In search for a material having a better wetting property with molten aluminum, we have found SiO₂ as a material which is easily available at a very low cost.

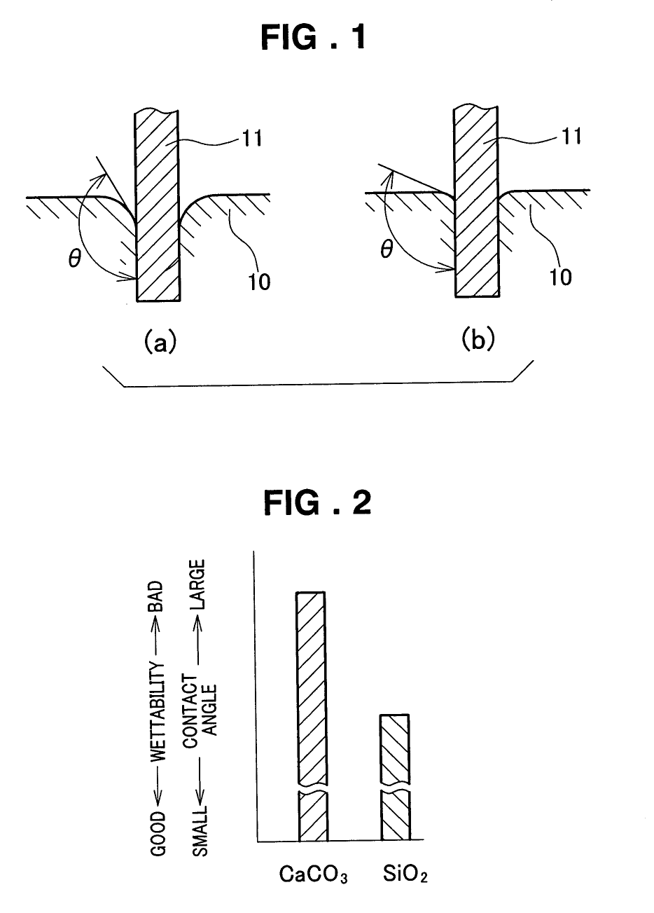

As shown in FIGS. 1(a) and (b), a test specimen 110 is vertically supported and lowered softly into a mass of molten metal 100 with the result that a depression is formed in the molten metal surface, with an angle θ left between an edge of the depression and the vertical line. Such an angle θ is called a contact angle and examined to determine the wetting property of a material with a molten metal.

In FIG. 1(a), a test specimen 110 of a low wetting property with molten metal 100 is lowered into a mass of the molten metal. The contact angle θ is relatively large as the test specimen has a low wetting property with the molten metal. In contrast, in FIG. 1(b), a test specimen 110 of a high wetting property with molten metal 100 is lowered into a mass of the molten metal. The contact angle θ is relatively small as the test specimen has a high wetting property with molten metal. Thus, the wetting property of a certain material with molten metal can be determined from its contact angle θ.

Reference is now made to the graph of FIG. 2, showing the contact angle and wetting property of two different materials as determined by the method described with reference to FIGS. 1(a) and (b). The test specimens 110 were of CaCO₃ and SiO₂, respectively, and their contact angles were examined by employing molten aluminum as molten metal 100. We have found CaCO₃ with a large contact angle and SiO₂ with a small contact angle. This has confirmed that SiO₂ has a satisfactorily good wetting property with molten aluminum as compared with CaCO₃. We have, therefore, considered that the coating of a powder of CaCO₃ with SiO₂ will make it possible to prevent the movement of bubbles and thereby the mutual bombardment and combination of bubbles during the initial stage of foaming by virtue of the action of SiO₂ having a good wetting property. We have tried to manufacture a foamed metal by doing so and obtained good results, as will be described in detail later.

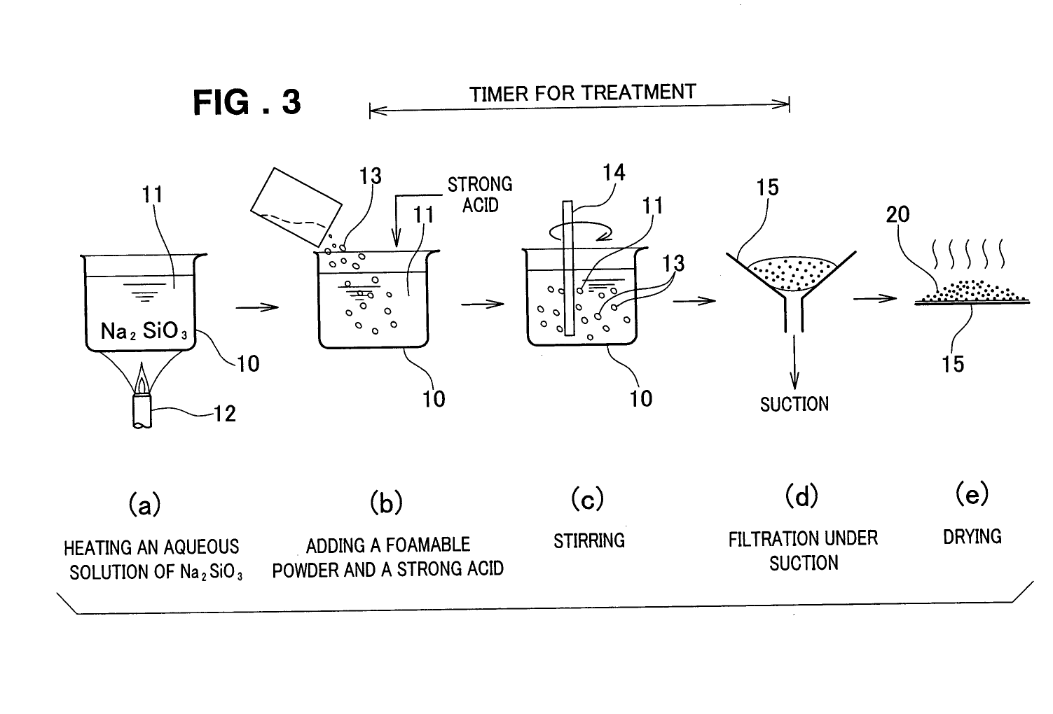

Description will now be made of a co-precipitation process for preparing a foaming agent according to this invention with reference to the flowchart of FIG. 3 showing a series of steps (a) to (e) constituting the process.

(a) An aqueous solution 11 of Na₂SiO₃ in a container 10 is heated to about 40° C. by a heater 12.

(b) A strong acid (e.g. hydrochloric acid) is mixed in the aqueous solution 11 of Na₂SiO₃ and a foamable powder 13 is put in it. The foamable powder 13 is preferably of a carbonate, such as calcium carbonate (CaCO₃) or magnesium carbonate (MgCO₃), as it produces carbon dioxide having no danger of explosion. Magnesium carbonate (MgCO₃) is easily available and can be prepared by the dehydration, etc. of highly stable basic magnesium carbonate (4 MgCO₃.Mg(OH₂).5H₂O).

(c) The aqueous solution 11 of Na₂SiO₃ hydrochloric acid (HCl) and foamable powder 13 are thoroughly stirred together by a stirrer 14. The stirring causes the following reaction to take place:

Na₂SiO₃(liquid)+2HCl(liquid)→2NaCl(liquid)+SiO₂(solid)+H₂O(liquid)

The liquid is an aqueous solution and the solid is a powder or film. SiO₂ (solid) is formed by the reaction of formation of colloidal silicic acid which occurs when hydrochloric acid (HCl), which is a strong acid, is added to the aqueous solution of Na₂SiO₃ to make it weakly acidic. This SiO₂ (solid) covers the particle surfaces of CaCO₃. As SiO₂ is very likely to occur in the form of a silica gel (SiO₂.nH₂O), SiO₂ forming a coating layer of SiO₂ according to this invention includes a silica gel.

(d) The mixed solution is filtered by a filtering material 15, such as filter paper. The filtering work is promoted by suction.

(e) The filtrate is dried to yield a desired foaming agent 20.

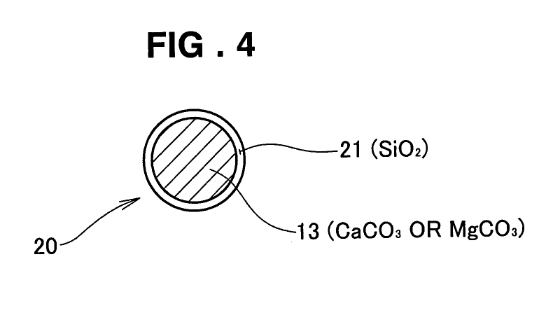

FIG. 4 is a schematic illustration of a particle of the foaming agent according to this invention. The foaming agent 20 is composed of a particle 13 of a foamable powder of CaCO₃ or MgCO₃ and a coating layer 21 of SiO₂ covering the surface of the particle 13.

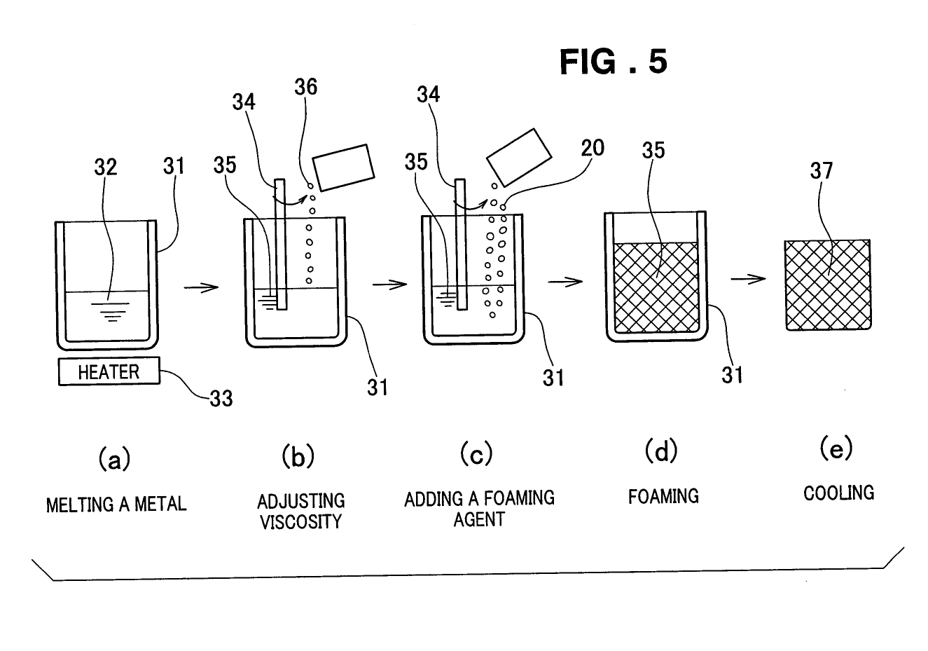

Description will now be made of a process for manufacturing a foamed or porous metal by using the foaming agent 20 described above. FIG. 5 shows a series of steps (a) to (e) of the process.

(a) A silicon-aluminum alloy 32 containing 7% of silicon is melted in a crucible 31 by heating to about 700° C. by a heater 33. When vacuum melting is employed, this and subsequent steps are carried out in a vacuum furnace, though no vacuum furnace is shown or described.

(b) A viscosity adjusting agent 36, such as Ca or Mg, is put in the molten alloy 35 to adjust its viscosity, while the molten alloy 35 is stirred by a stirrer 34.

(c) An adequate amount of foaming agent 20 is put in the molten alloy 35.

(d) The gasified foaming agent 20 increases the volume of the molten alloy 35. Its cooling is started.

(e) When it has been cooled to an adequate temperature, the alloy is removed from the crucible and cooled to a further extent to yield a foamed or porous metal 37.

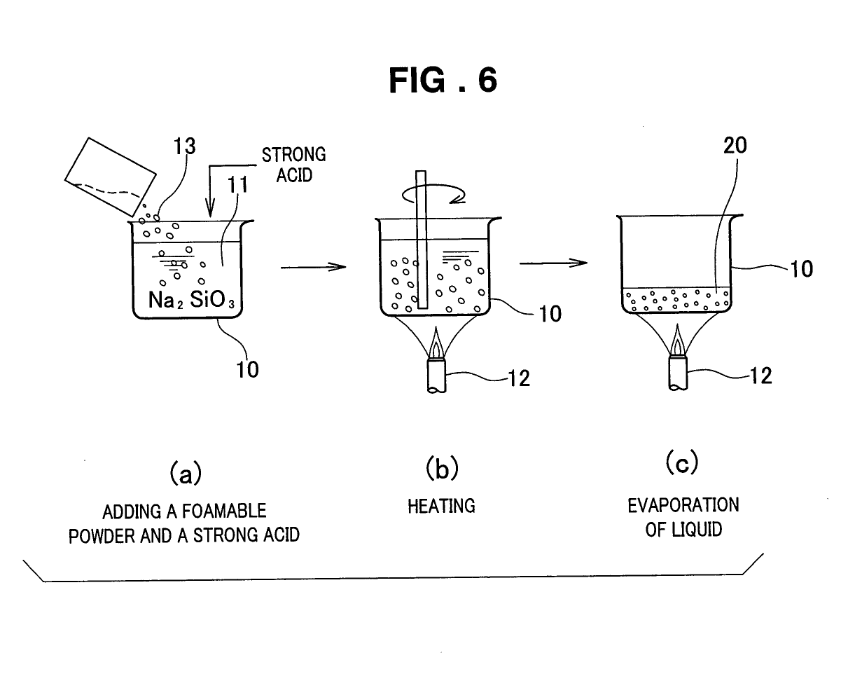

Although the co-precipitation process shown in FIG. 3 has been described for the preparation of the foaming agent according to this invention, the foaming agent according to this invention can be prepared by an evaporation process, too. Attention is, therefore, directed to FIG. 6 showing the evaporation process.

(a) A strong acid and a foamable powder 13 are put in an aqueous solution 11 of Na₂SiO₃ in a vessel 10.

(b) The aqueous solution 11 of Na₂SiO₃, strong acid and foamable powder 13 are stirred together, while the vessel 10 is heated by a heater 12. The stirring causes the following reaction to take place:

Na₂SiO₃(liquid)+2HCl(liquid)→2NaCl(liquid)+SiO₂(solid)+H₂O(liquid)

The reaction has already been described and no repeated description is, therefore, made.

(c) The heating of the vessel 10 by the heater 12 is continued to evaporate water and eventually yield a foaming agent 20. Each particle of the foaming agent 20 has a cross sectional structure as described before with reference to FIG. 4.

Although an aluminum alloy is, as a principle, used to make a foamed or porous metal (or alloy), it is, of course, possible to use any other metal or alloy, such as a magnesium alloy, an iron alloy or stainless steel. Although the foamable powder is preferably of a carbonate, it is also possible to use any other material that is usually employed for a foaming agent. Although hydrochloric acid has been used as a strong acid, it is also possible to employ any other strong acid, such as sulfuric or nitric acid.

### EXAMPLES

The invention will now be described more specifically with reference to experimental examples, though the following description is not intended for limiting the scope of this invention.

A. Conditions for Preparation of a Foaming Agent

Process: Co-precipitation

Na₂SiO₃ (liquid): 2.0% by mass

CaCO₃ (solid)/Na₂SiO₃ (liquid)=0.21 g/g

pH: 6.87

Drying temperature: 100° C.

B. Conditions for Manufacture of a Foamed Metal

Metal to be melted: A silicon-aluminum alloy containing 7% of silicon

Melting apparatus: A vacuum melting furnace

Melting temperature: 700° C.

Viscosity adjusting agent: Ca and Mg

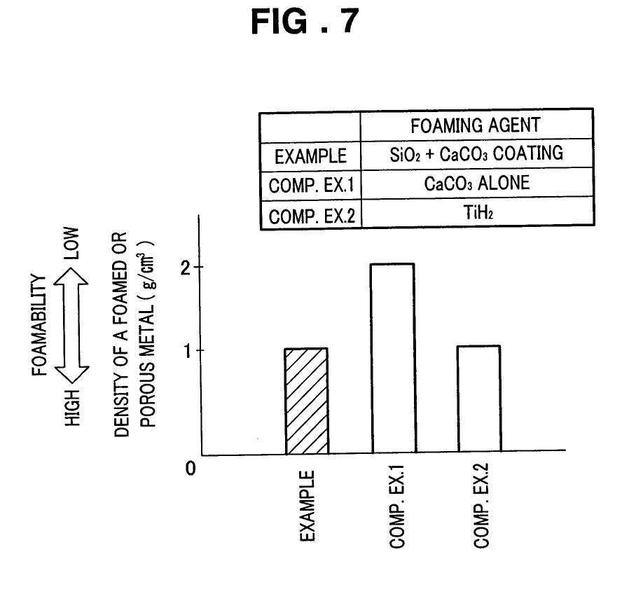

FIG. 7 is a graph showing the density of the foamed or porous metals obtained in accordance with the Example employing the foaming agent of this invention, as well as Comparative Examples. The product obtained by employing the foaming agent composed of CaCO₃ and a coating layer of SiO₂ according to this invention showed a density of about 1.0 g/cm³. On the other hand, the product according to Comparative Example 1, which had been made by employing a foaming agent composed of CaCO₃ alone, showed a density of about 1.8 g/cm³ and the product according to Comparative Example 2, which had been made by employing an old foaming agent composed of TiH₂, showed a density of about 1.0 g/cm³. A lower density means a higher degree of foaming, as shown by an arrow beside the graph in FIG. 7. As is obvious therefrom, the product obtained by employing the foaming agent according to this invention was by far lower in density and higher in foaming degree than that according to Comparative Example 1, and was comparable to the product according to Comparative Example 2.

Obviously various minor changes and modifications of the present invention are possible in the light of the above teaching. It is therefore to be understood that within the scope of the appended claims the invention may be practiced otherwise than as specifically described.

What is claimed is:

1. A foaming agent used for manufacturing a foamed or porous metal, comprising:
a foamable powder; and
a coating layer of SiO₂ covering the particle surfaces of the powder.

2. The foaming agent according to claim 1, wherein the powder is of a carbonate.

3. The foaming agent according to claim 2, wherein the carbonate is CaCO₃ or MgCO₃.
